(19) United States
(12) Patent Application Publication
(10) Pub. No.: US 2022/0130353 A1
(43) Pub. Date: Apr. 28, 2022

(54) DETACHABLE, PORTABLE RESONANCE BOX FOR PROVIDING ACOUSTIC STEREO SOUND FROM STRINGED INSTRUMENTS

(71) Applicant: Zeki Caglar NAMLI, Istanbul (TR)

(72) Inventor: Zeki Caglar NAMLI, Istanbul (TR)

(21) Appl. No.: 17/295,898

(22) PCT Filed: Nov. 26, 2018
(86) PCT No.: PCT/TR2018/050728

§ 371 Date: May 21, 2021

(30) Foreign Application Priority Data
Nov. 23, 2018 (TR) 2018/17785

(51) Int. Cl. G10D 3/02; G10K 11/08

(52) U.S. Cl. CPC G10D 3/02; G10K 11/08

(57) ABSTRACT

The present invention relates to a detachable, portable resonance box (1) for providing acoustic stereo sound from stringed instruments and it comprises a primary sound transmission rod (2) which receives and transmits sound vibrations by contacting directly or by means of a connecting apparatus (11) to any area on the body and neck of the stringed instruments, one to four secondary sound transmission rods (3) which are connected to the primary sound transmission rod (2) as a branch or projected downward independently from the primary sound transmission rod (2) and directly contacted to the relevant region of the stringed instrument (13), a primary resonance zone (4), one to four secondary resonance zones (5), a cap (6), a primary resonance cavity (9), one to four secondary resonance cavities (10), a primary sound routing hole (7).

### TECHNICAL FIELD

This invention relates to a detachable, portable resonance box for providing acoustic stereo sound from stringed instruments.

### PRIOR ART

As it is known, stringed instruments are composed of 3 main parts, namely body, neck and strings. The body is, in fact, a resonance box that resonates and amplifies (increase the strength) the sound waves formed by playing the strings. Because the inside of the body is empty, the sound waves move freely, hit the walls of the body and come back. Thus they are amplified.

Normal stringed musical instruments have one body, namely one resonance box. One direction sound is transmitted from this resonance box to outside. Today, some electronic devices are used to make the sound as two directional, stereo sound. Thanks to these devices, electronic stereo sound can be obtained from stringed instruments. However, in order to obtain acoustic stereo sound, very little work has been done on existing stringed instruments. As a result of these studies, products with efficient results have not emerged.

For example, in the utility model No. 2006/02443 registered in Turkey and entitled “Stringed musical instrument with double resonance box” which belongs to the inventor of the present invention, a second resonance box which is stationary and fixed to the instrument is described.

Similarly, U.S. Pat. No. 7,342,158 B2 entitled “Musical instrument with multiple resonance chambers” describes two interconnected and fixed resonance boxes. Also, U.S. Pat. No. 4,903,567 entitled “Guitar with dual sound chambers” describes two separate sound boxes in the same fiberglass body.

In addition, CN104485087 A patent document entitled “Double box 21 or 25-stringed plucked instrument”, CN107945772 A patent document entitled “Multifunctional guitar with double musical instrument bodies”, CN104464691 A patent document entitled “Double box seven stringed plucked instrument”, CN2812200 Y patent document entitled “Drawing string musical instrument with vertical sound panel and double sound boxes”, CN202394514 U patent document entitled “Drawing string musical instrument with double sound boxes”, CN2533543 Y patent document entitled “Multiple resonance device in resonator of stringed instruments”, which are all Chinese patent publications, disclose various secondary sound boxes. None of these documents mentions a resonance box which is detachable, portable and also has sound transmission rods.

In addition, the Sitar, one of the traditional Indian instruments, has a second resonance box on the neck part of the instrument. This resonance box is also used as a stopping device when placing the instrument on the floor. The portable resonance box according to the present invention is completely different from the resonance box of the traditional Indian instrument. We can briefly describe these differences. The resonance box on the sitar is a non-portable box fixed to the neck of the instrument. This resonance box is a box that can only be used on the sitar and cannot be attached to other instruments. However, the portable resonance box of the present invention can be attached to and removed from any stringed instrument. Violin, guitar, lute, violin, mandolin, baglama (Turkish folk musical instrument) are just some of these instruments. The primary sound transmission rod, secondary sound transmission rods and secondary resonance zones in the portable resonance box according to the present invention are not available in the resonance box of the sitar. In addition, there is no primary sound routing hole and secondary sound routing holes to guide the sound waves that resonate inside. Furthermore, the resonance box in the sitar cannot be attached into the desired position of the stringed instrument as the portable resonance box according to the present invention. It is only fixed to a specific position on the neck. In summary, the additional resonance box mounted in the traditional Indian instrument is a simple closed object used to base the instrument on the ground. However, the portable resonance box according to the present invention is an advanced tool that can be attached and removed anywhere on the instrument which is capable of receiving the sound from the stringed instrument by means of the sound transmission rods, resonating in the primary and secondary resonance zones and thereby amplifying the sound, releasing it with the sound routing holes, and producing a very nice, effective acoustic stereo sound.

With the portable resonance box according to the present invention, a brand new product that can be attached and removed anywhere on the instrument, and which receives sound vibrations, transmits to the resonance zones and resonates there and transmits the sound waves amplified in this way to the outside by means of routing holes and thus produces an acoustic stereo sound is created.

### SUMMARY OF THE INVENTION

The present invention relates to a detachable, portable resonance box for providing acoustic stereo sound from stringed instruments and it comprises a primary sound transmission rod which receives and transmits sound vibrations by contacting directly or by means of a connecting apparatus to any area on the body and neck of the stringed instruments, one to four secondary sound transmission rods which are connected to the primary sound transmission rod as a branch or projected downward independently from the primary sound transmission rod and directly contacted to the relevant region of the stringed instrument, a primary resonance zone, one to four secondary resonance zones, a cap, a primary resonance cavity, one to four secondary resonance cavities, a primary sound routing hole.

### DESCRIPTION OF FIGURES

FIG. 1 gives a bottom perspective view of the portable resonance box according to the present invention,

FIG. 2 gives a side view of the portable resonance box according to the present invention,

FIG. 3 gives a top view of the portable resonance box according to the invention,

FIG. 4 gives a view of the portable resonance box according to the invention when the cap is open,

FIG. 5a shows the secondary sound transmission rods which have straight shape in another preferred embodiment of the present invention,

FIG. 5b shows the secondary sound transmission rods which have broken shape in yet another preferred embodiment of the present invention,

FIG. 6 shows the portable resonance box of the present invention as it is attached to the end of the guitar neck,

FIG. 7 shows the portable resonance box according to the present invention attached to the side of guitar neck so that the primary sound routing hole is directed upward,

FIG. 8 shows the portable resonance box according to the present invention attached to the side of guitar neck so that the primary sound routing hole is directed to the side,

FIG. 9 shows the portable resonance box according to the present invention positioned on the upper surface of the guitar body,

FIG. 10 shows the portable resonance box of the present invention and the connecting apparatus,

FIG. 11 illustrates the portable resonance box according to the present invention as it is attached to the connecting element,

FIG. 12 illustrates the portable resonance box according to the present invention as it is positioned on the clamp,

FIG. 13 illustrates the portable resonance box according to the present invention as it is positioned on the capo,

FIG. 14 illustrates the secondary sound transmission rods which have broken shape, positioned on the clamp in a preferred embodiment of the present invention.

### REFERENCES

1 Portable resonance box
2 Primary sound transmission rod
3 Secondary sound transmission rod
4 Primary resonance zone
5 Secondary resonance zone
6 Cap
7 Primary sound routing hole
8 Secondary sound routing hole
9 Primary resonance cavity
10 Secondary resonance cavity
11 Connecting apparatus
12 Fingerboard upper portion
13 Stringed instrument
14 Stationary resonance box
15 Upper surface
16 Clamp
17 Capo

### DETAILED DESCRIPTION OF THE INVENTION

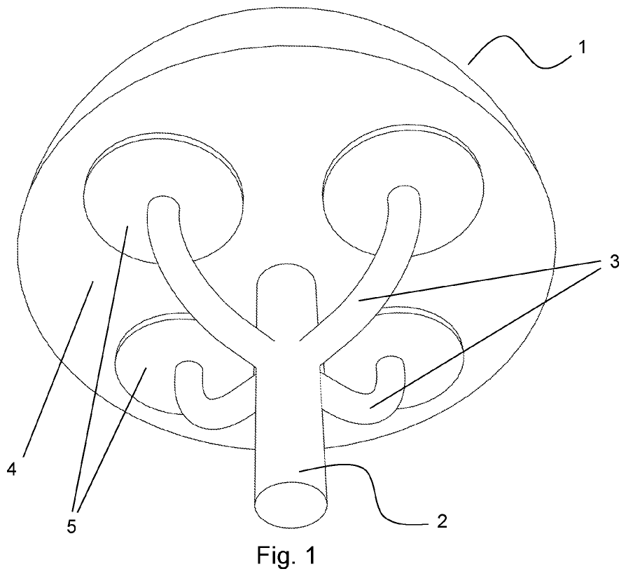

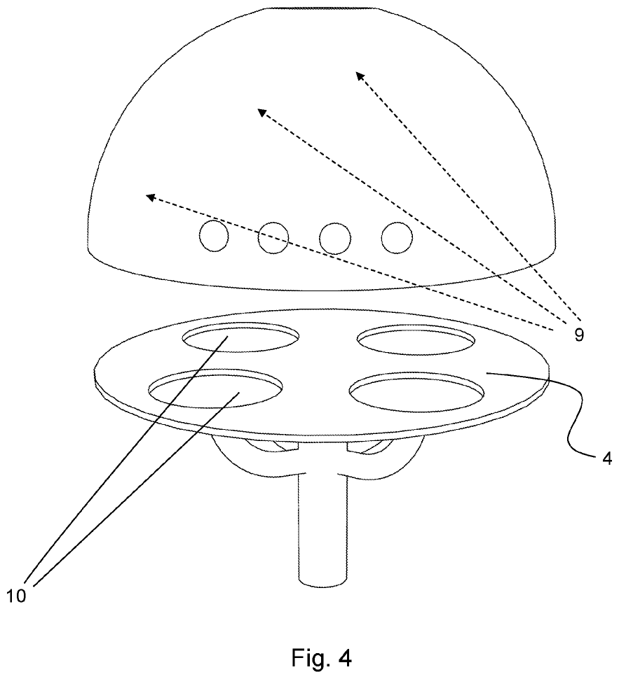

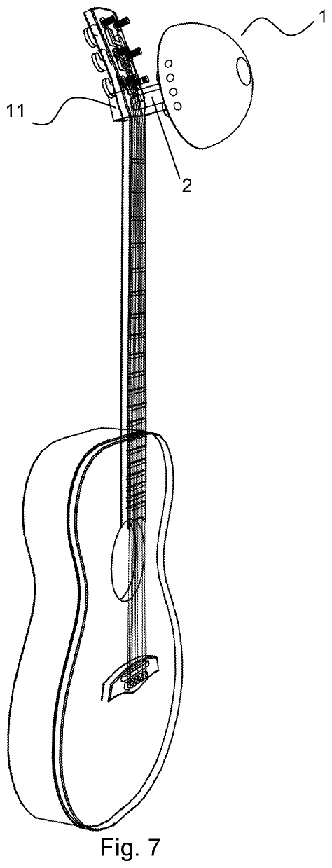

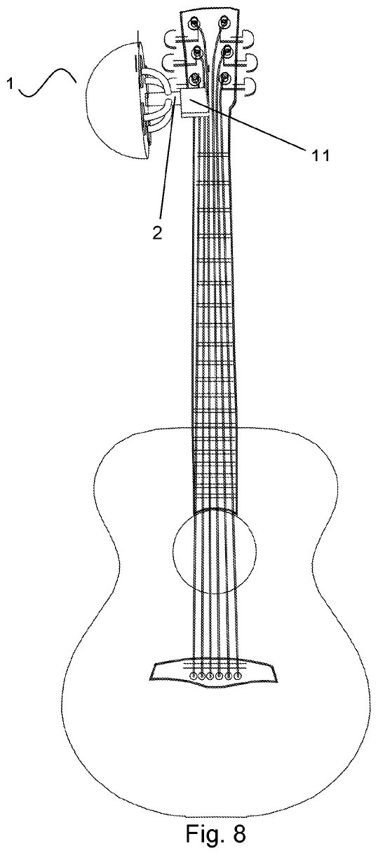

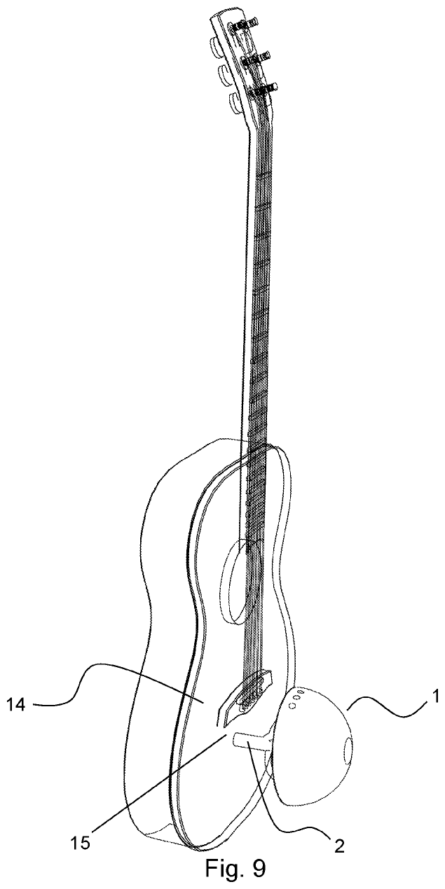

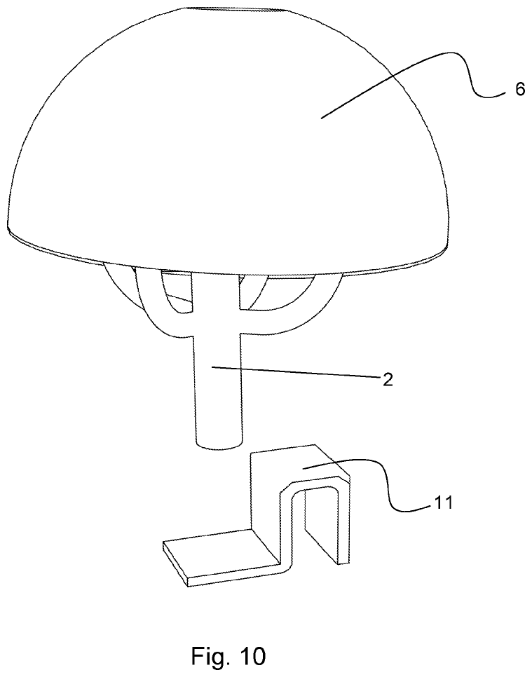

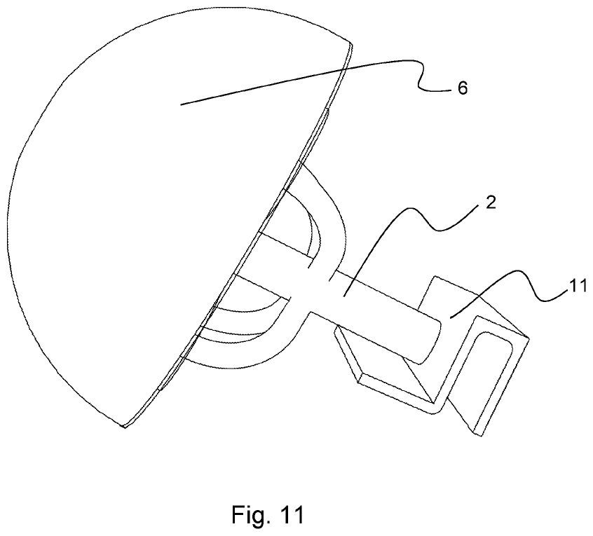

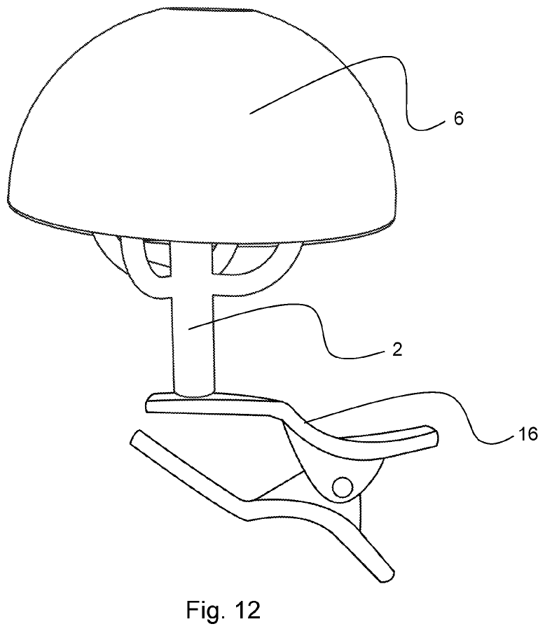

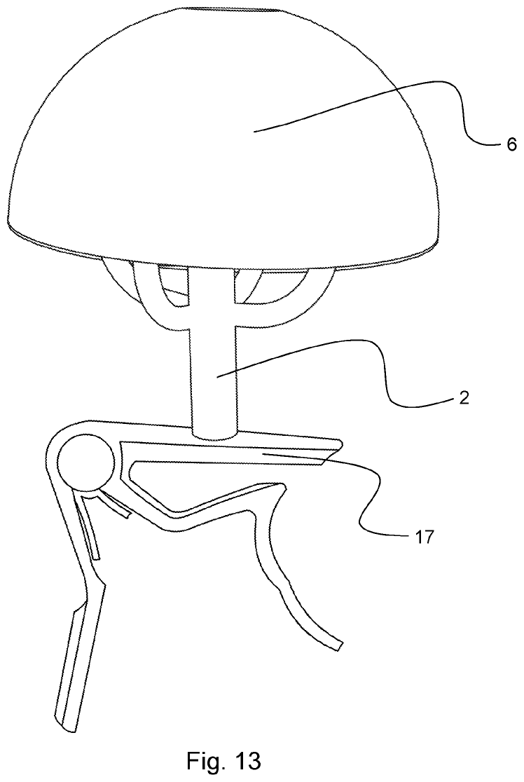

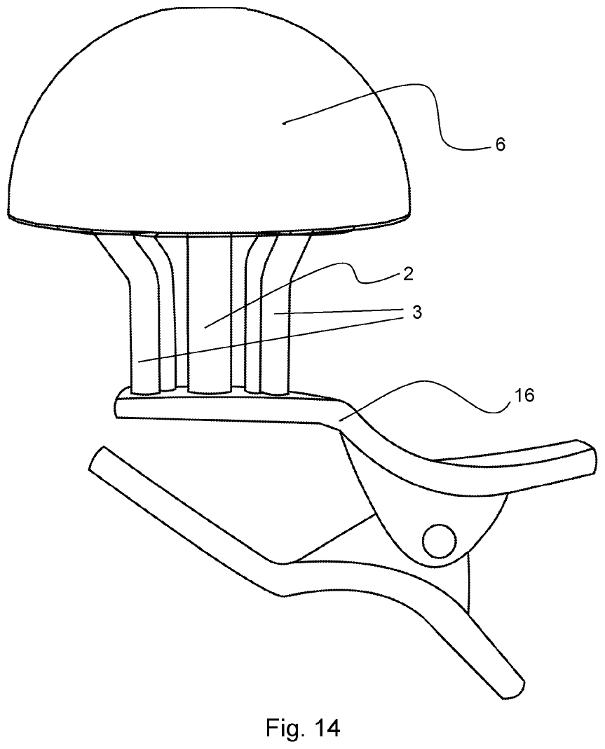

The present invention relates to a detachable, portable resonance box (1) for providing acoustic stereo sound from stringed instruments. As seen in FIG. 1 to FIG. 14, the portable resonance box (1) according to this invention comprises a primary sound transmission rod (2) which receives and transmits sound vibrations by contacting directly or by means of a connecting apparatus (11) to any area on the body and neck of the stringed instruments, one to four secondary sound transmission rods (3) which are connected to the primary sound transmission rod (2) as a branch or projected downward independently from the primary sound transmission rod (2) and directly contacted to the relevant region of the stringed instrument, a primary resonance zone (4) in the form of a thin plate, to which the primary sound transmission rod (2) is connected, one to four secondary resonance zones (5) in the form of a thin plate, to which the secondary sound transmission rods (3) are connected, a cap (6) positioned above the primary resonance zone (4) and the secondary resonance zones (5), allowing the sound to be resonated by being confined inside, a primary resonance cavity (9) formed by the air gap between the primary resonance zone (4) and the cap (6); one to four secondary resonance cavities (10) in the shape of a hole, positioned above each secondary resonance zone (5), a primary sound routing hole (7) positioned on the cap (6) for guiding the sound waves vibrated between the primary resonance zone (4), secondary resonance zones (5) at the bottom and the cap (6) above.

A portable resonance box (1) according to the present invention further comprises one or several secondary sound routing holes (8) positioned on the cover (6). The diameter of said secondary sound routing hole (8) is preferably smaller than the diameter of the primary sound routing hole (7). In addition, the portable resonance box (2) is positioned on a surface of said connecting apparatus (11) and that the neck or body of the stringed instrument (13) is positioned between the other surfaces of the connecting apparatus (11).

A portable resonance box (1) according to the present invention, is positioned on the fingerboard upper portion (12) of the stringed instrument (13) by means of direct contact or via the connecting apparatus (11). Furthermore, the portable resonance box (1) is positioned on the upper surface (15) of the stationary resonance box (14) which constitutes the body of the stringed instrument (13) by means of direct contact or via the connecting apparatus (11). In the present invention, a wide variety of connecting apparatus can be used. There is no limitation. For example, said connecting apparatus (11) may be a clamp (16). Or said connecting apparatus (11) is a capo (17).

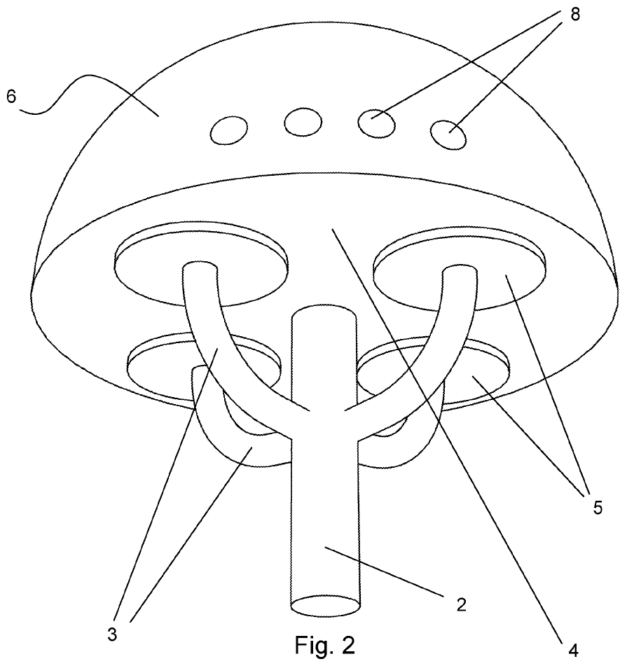

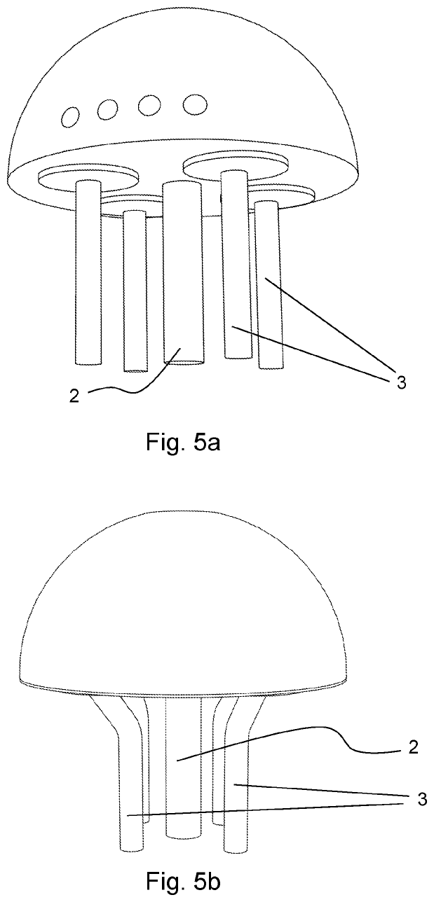

As shown in FIG. 2, in a preferred embodiment of the present invention, the secondary sound transmission rods (3) are connected to the primary sound transmission rod (2) like a branch. In another preferred embodiment of the present invention, the secondary sound transmission bars (3) extend straight downward as shown in FIG. 5a. In this case, the secondary sound transmission rods (3), together with the primary sound transmission rod (2), contact the corresponding part of the stringed instrument (13) to receive the sound. In yet another preferred embodiment of the present invention, as shown in FIG. 5b, the secondary sound transmission rods (3) can descend with a downward angle to narrow the lower contact area.

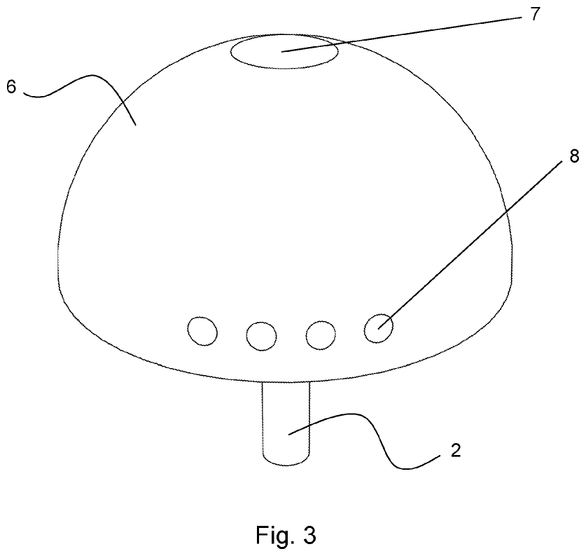

Primary sound transmission rod (2), secondary sound transmission rods (3), primary resonance zone (4), secondary resonance zone (5) and cap (6) according to the present invention, can be made of plastic, wood, thin metal sheet, animal skin, fiberglass and similar materials. The important thing here is to use materials that give good results in voice transmission. The primary sound transmission rod (2), secondary sound transmission rods (3), may preferably be made of wood, metal or spring. The primary sound routing hole (7) can be positioned where the sound emission is desired. In a preferred embodiment of the invention, as shown in FIG. 3, the primary sound routing hole (7) is positioned at the top of the hemispherical cap (6). This hole, however, can be optionally positioned at different locations. In a preferred embodiment of the present invention, the secondary sound routing holes (8) are positioned on the lower side of the cap (6). This is an optional preference. The positions and the number of these holes can also be changed. As mentioned above, the primary sound transmission rod (2) in the portable resonance box (1) according to the present invention can also be connected to a desired location of the instrument without the connecting apparatus (11). This connection may be in the form of gluing, screwing, fitting, hook, snap fit clip.

In a preferred embodiment of the portable resonance box (1) according to the present invention illustrated in the attached figures, the resulting appearance resembles a hemisphere. Therefore, the product resulting from the present invention is called, without limitation, “sound ufo” or “sound tree of life” due to its branched appearance.

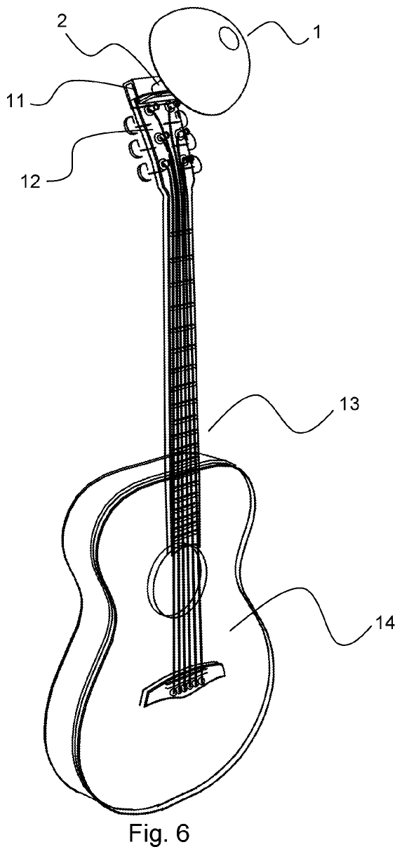

In the attached FIGS. 6 to 9, guitar is used as a stringed instrument (13), without limitation. The portable resonance box (1) according to the present invention can be used in all stringed instruments.

In practice, for example, the portable resonance box (1) attached to the fingerboard upper portion (12) of the guitar provides a very sweet, acoustic stereo sound to the person who plays the instrument and the surrounding people. This makes the playing of the musical instrument more enjoyable. In the music industry, for the electronically generated stereo sound, two sounds are electronic copies of each other. However, since the secondary sound produced by the portable resonance box (1) according to the present invention is different from the primary sound produced by the stationary resonance box (14), it allows a much more natural and acoustic stereo sound to be produced. In addition, there is no need for a modification to the existing instrument for the production of this acoustic stereo sound. Because the portable resonance box (1) according to the present invention can be attached and removed on the neck or the body of the instrument wherever it is desired.

As a result, with the present invention, for the music industry, a brand new and pioneer product that converts the sound of stringed instruments into acoustic stereo sound, and which receives the sound, transmits to the resonance zones (4,5) by means of sound transmission rods (2, 3) and resonates there, amplifies the sound and routes the sound to the medium by means of routing holes (7, 8) is provided.

1) A detachable, portable resonance box for providing acoustic stereo sound from stringed instruments, comprising:
a primary sound transmission rod which receives and transmits sound vibrations by contacting directly or by means of a connector to any area on the body and neck of the stringed instruments,
one to four secondary sound transmission rods which are connected to the primary sound transmission rod as a branch or projected downward independently from the primary sound transmission rod and directly contacted to the relevant region of the stringed instrument,
a primary resonance zone in the form of a thin plate, to which the primary sound transmission rod is connected,
one to four secondary resonance zones in the form of a thin plate, to which the secondary sound transmission rods are connected,
a cap positioned above the primary resonance zone and the secondary resonance zones, allowing the sound to be resonated by being confined inside,
a primary resonance cavity formed by the air gap between the primary resonance zone and the cap;
one to four secondary resonance cavities in the shape of a hole, positioned above each secondary resonance zone,
a primary sound routing hole positioned on the cap for guiding the sound waves vibrated between the primary resonance zone, secondary resonance zones at the bottom and the cap above.

2) A portable resonance box according to claim 1, wherein it further comprises one or several secondary sound routing holes positioned on the cover.

3) A portable resonance box according to claim 1, wherein the diameter of the secondary sound routing hole is smaller than the diameter of the primary sound routing hole.

4) A portable resonance box according to claim 1, wherein the portable resonance box is positioned on a surface of said connector and that the neck or body of the stringed instrument is positioned between the other surfaces of the connector.

5) A portable resonance box according to claim 1, wherein the portable resonance box is positioned on the fingerboard upper portion of the stringed instrument by means of direct contact or via the connector.

6) A portable resonance box according to claim 1, wherein the portable resonance box is positioned on the upper surface of the stationary resonance box which constitutes the body of the stringed instrument by means of direct contact or via the connector.

7) A portable resonance box according to claim 1, wherein said connector is a clamp.

8) A portable resonance box according to claim 1, wherein said connector is a capo.
